(19) United States
(12) Patent Application Publication
(10) Pub. No.: US 2005/0206613 A1
(43) Pub. Date: Sep. 22, 2005

(54) Method and system for power management of an optical mouse

(76) Inventors: Wai San Chan, Taman Belimbing (MY); Wee Tap Albert Lim, Taman Pekaka (MY); Chun Kit Wong, Taman Brown (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/803,598

(22) Filed: Mar. 17, 2004

(51) Int. Cl. G09G 5/00

(52) U.S. Cl. 345/156

(57) ABSTRACT

A system and method for power management of an optical mouse. A mechanical displacement sensor associated with the optical mouse is used to detect movement of the optical mouse. When the optical mouse is motionless, a switch within the mechanical displacement sensor sets the optical mouse to a standby state. The standby state conserves power. When motion is detected by the mechanical displacement sensor, the switch powers up the optical mouse into its normal mode of operation.

### FIELD OF THE INVENTION

The present claimed invention relates to the field of optical input devices. Specifically, the present claimed invention relates to power management in an optical mouse.

### BACKGROUND ART

As you may know, the optical mouse is replacing the conventional ball mouse. In general, this replacement is due to the better navigation performance and maintenance-free solid-state navigation technology of the optical mouse. These advantages overshadow the ball mouse and as the cost of the optical mouse drops, the ball mouse will be increasingly phased out.

However, the optical mouse has a few limitations of its own. Specifically, the optical mouse has a higher overall power consumption than the ball mouse. This issue of power consumption is especially vital in regard to wireless mouse and portable computer systems which operate on batteries. Therefore, power management is an important aspect of optical mouse technology, especially in regard to a wireless mouse and/or portable computing system.

In general, the main power consumption of the optical mouse module is attributed to the optical mouse sensor and XY-LED. In order to reduce the power consumption, the mouse sensor automatically positions itself into a sleep mode as soon as there is no movement being detected. In some cases, that may be as quickly as a one-second duration. During this mode, the mouse sensor periodically wakes up (e.g., every 12 frames=8 ms at 1500 frames/s) to check for movement in either the X- or Y-axis directions. In addition, the XY-LED will pulse at a lower duty cycle in order to reduce the power used to light up the navigation surface. Although this power reducing method is well established, the overall power consumption of an optical mouse is still relatively high.

In addition, whenever the optical mouse is in a standby state for long periods (e.g., overnight, lunch, day off, vacation, etc.) the optical mouse still detects for motion (e.g., after every 8 ms) and both the XY-LED and the mouse sensor still consumes power. Therefore, another prior way to reduce power consumption is to use a microcontroller to power down the mouse sensor after prolonged inactivity (e.g., a few seconds). This improves the current and power optimization. However, in order to re-activate the mouse, a manual interrupt (e.g., by clicking the mouse button, scrolling the Z-wheel, or the like) is necessary. This practice is deleterious as a user would have to click the mouse after realizing that the mouse had powered down (e.g., when it fails to move). This type of prior power management operation may cause significant user annoyance and, therefore, is not widely practiced by optical mouse manufacturers.

Under normal usage, a wireless mouse has a battery life of only a couple of weeks or less. This minimal battery lifetime requires significant user interaction and causes user frustration. One remedy to the problem is a rechargeable wireless optical mouse wherein the mouse is placed in a cradle or docking station to recharge. However, this solution requires the user to remember to place the mouse in the cradle on a daily or weekly basis. In addition, the portability aspect, e.g., the need to bring a mouse cradle in conjunction with a portable PC, is awkward and troublesome.

Therefore, a need exists for an optical mouse which has improved power management characteristics.

### SUMMARY

A system and method for power management of an optical mouse includes a mechanical displacement sensor within the optical mouse to detect movement of the optical mouse. When the optical mouse is motionless, a switch associated with the mechanical displacement sensor sets the optical mouse to a standby state. The standby state conserves power. When motion is detected by the mechanical displacement sensor, the switch powers up the optical mouse into its normal mode of operation.

### BRIEF DESCRIPTION OF THE DRAWINGS

The accompanying drawings, which are incorporated in and form a part of this specification, illustrate embodiments of the invention and, together with the description, serve to explain the embodiments of the invention:

FIG. 1 is a circuit diagram of an exemplary mechanical displacement sensor in accordance with one embodiment of the present claimed invention.

FIG. 2 is a block diagram of an exemplary integrated mechanical displacement sensor in conjunction with an optical mouse sensor in accordance with one embodiment of the present claimed invention.

FIG. 3 is a block diagram of an exemplary optical mouse sensor with integrated mechanical displacement sensor in accordance with another embodiment of the present claimed invention.

FIG. 4 is a flowchart of steps in an exemplary method for power management of an optical mouse in accordance with one embodiment of the present invention.

The drawings referred to in this description should be understood as not being drawn to scale except if specifically noted.

### DESCRIPTION OF THE PREFERRED EMBODIMENTS

As an overview, the present invention provides in various embodiments, a mechanical displacement sensor integrated with an optical mouse sensor to provide significant power management capabilities to an optical mouse. In one embodiment, an optical mouse is a computer cursor control device that is implemented using optical navigation technologies. For example, the optical mouse emits a light and senses its reflection as it is moved. The mechanical displacement sensor signals a hibernating optical mouse to power up when movement (including vibration, or the like) is detected. This power management capability provides a highly optimized power management approach thereby improving battery lifetime for a wireless optical mouse while also providing seamless navigation for the user.

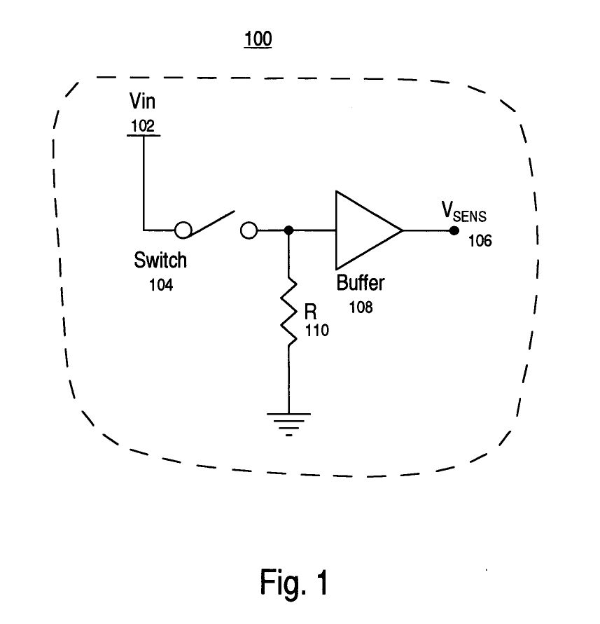

With reference now to FIG. 1 a circuit diagram of an exemplary mechanical displacement sensor is shown in accordance with one embodiment of the present claimed invention. In general, the mechanical displacement sensor 100 is used to detect mechanical movement of vibration from an idle static position. In one embodiment, the mechanical displacement sensor 100 includes a voltage in 102, a switch 104, a resistor 110, a buffer 108, and a voltage sensor 106. Although FIG. 1 shows specific components, the present invention is well suited to other types of mechanical displacement sensors (e.g., motion detecting circuits). The use of the specific components of FIG. 1 is merely for purposes of illustration.

Voltage 102 is simply the connection to the power source of the optical mouse. In one embodiment, voltage 102 may be 3.3 volts. In one embodiment, the voltage 102 may be provided by two AA batteries. However, any number or type of batteries may be used. In addition, the voltage supplied by voltage 102 may vary depending on the power source utilized by the optical mouse. In one embodiment, switch 104 is a standard sensor switch that defaults to the open position (e.g., open circuit) when no motion (or vibration) is present. However, when motion (or vibration) occurs, switch 104 closes (e.g., complete the circuit). In one embodiment, resistor 110 is a pull-down resistor. In general, resistor 110 is used to drain the circuit back down to zero (e.g., change input on buffer 108 to zero) after switch 104 reopens. Buffer 108 is a logic component which is used to output either a high logic (e.g., logic 1“motion”) or a low logic (e.g., logic 0 “static”). The voltage sensor 106 is a logic output of the voltage from the buffer 108 and may be output to a device or component connected therewith.

Thus, by connecting the mechanical displacement sensor 100 in a configuration similar to that of FIG. 1, a circuit can be used to convert any physical displacement to an electric pulse. For example, when movement (or vibration) is present, switch 104 closes, current flows through resistor 110, and a voltage exists at the input of the buffer 108. This in turn produces a high logic at Voltage sensor 106, the output of the buffer 108. In one embodiment, the total current consumption may be only a few micro amps (depending on the value of resistor 110). Only a pulse is needed for the buffer 108 to output the high logic. In one embodiment, once the movement is detected and the high logic signal is generated, the circuit may be switched off (e.g., switch 104 defaults to open) until the next detection of motion occurs.

Therefore, not only is the current consumption very low, but it is very brief as well. In the static state (e.g., open switch 104), mechanical displacement sensor 100 consumes almost no power. Voltage sensor 106 at this state is low logic. Additionally, only the standby current is required by the buffer. Thus, there is essentially no power consumption when the mechanical displacement sensor 100 is in the open state.

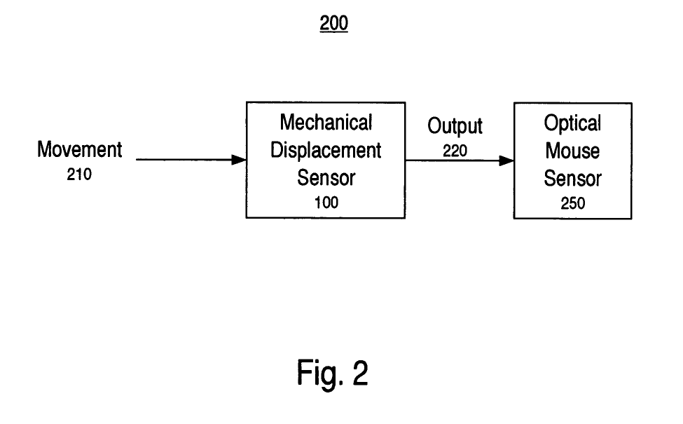

With reference now to FIG. 2, a block diagram of an exemplary integrated mechanical displacement sensor in conjunction with an optical mouse sensor is shown in accordance with one embodiment of the present claimed invention. Specifically, FIG. 2 shows the actions of the mechanical displacement sensor 100 integrated with an exemplary optical mouse sensor 250. Circuit 200 illustrates the plug-and-play capabilities of the mechanical displacement sensor 100. FIG. 2 also includes movement 210 which may be any motion or vibration of the optical mouse and output 220 which is the output received from the logic of buffer 108 at voltage sensor 106.

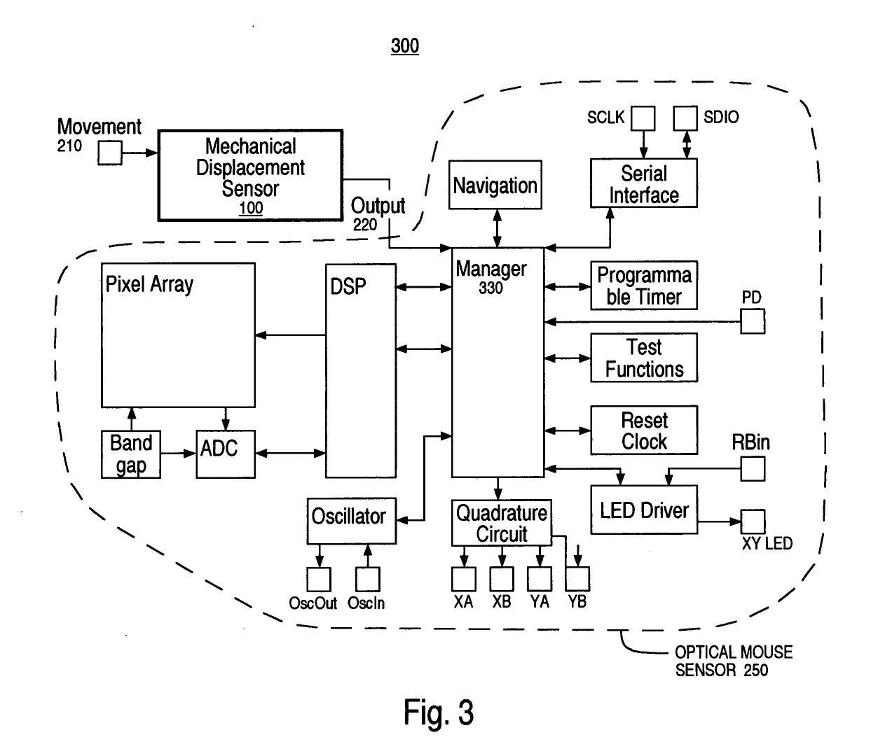

In one embodiment, during active usage, the mouse module incurs movement. However, when the activity ends (e.g., no movement is detected) the mouse is powered down. That is, the power to the optical mouse sensor 250 is cut off. Therefore, the optical mouse sensor 250 is not able to detect any future movement as the vital analog and digital core of the navigation engine is powered down. In this state, the mouse module consumes significantly lower current and incurs markedly improved battery life as compared to an optical mouse module having an optical mouse sensor with a powered up analog and digital core. However, in the state of navigation engine shut down, the optical mouse sensor 250 does not respond to any motion of the optical mouse. Therefore, an outside input is necessary to tell the navigation engine of the optical mouse sensor 250 to power up. Thus, mechanical displacement sensor 100 is used to signal the optical mouse sensor 250 of motion detected at the optical mouse. This interaction is described in detail with respect to FIG. 3.

With reference now to FIG. 3 a block diagram of an exemplary optical mouse sensor with integrated mechanical displacement sensor is shown in accordance with another embodiment of the present claimed invention. The components of optical mouse sensor 250 are exemplary. That is, there are a plurality of possible components and configurations for an optical mouse sensor 250 which are well known in the art.

With reference now to FIG. 3 and FIG. 1, when the output 220 of the mechanical displacement sensor 100 (e.g., the voltage at voltage sensor 106) is integrated with the optical mouse sensor 250, the input necessary to tell the navigation engine of the optical mouse sensor 250 to power up is found. That is, when the mechanical displacement sensor 100 is integrated, the essentially zero current consumption sensor (when off) detects any movement in the mouse. Once movement is detected, the output of buffer 108 is at a high logic state. This high logic state is detected by the power management control circuit 330. The control circuit 330 then triggers the optical mouse sensor 250 to resume from a power-down mode (e.g., powering up). Then, when no motion is detected for the prescribed period of time, the optical mouse sensor 250 is again powered down to a non-motion aware state and the method described herein is repeated. That is, when motion is sensed mechanical displacement sensor 100 outputs high logic to signal the optical mouse sensor 250, the optical mouse sensor 250 powers up from the powered down state. Then, when no motion is detected for specified time period the optical mouse sensor 250 powers down to a non-motion aware state, etc.

Under the power management scheme 300 (e.g., mechanical displacement sensor 100 signaling the optical mouse sensor 250), it is possible to manufacture an optical mouse module that lasts for extended periods of time due to the reduced power consumption. In addition, in one embodiment, the mechanical displacement sensor 100 may be designed as an integrated add-on to an existing optical mouse sensor circuit 250. This capability helps in power management while also incurring minimal additional costs.

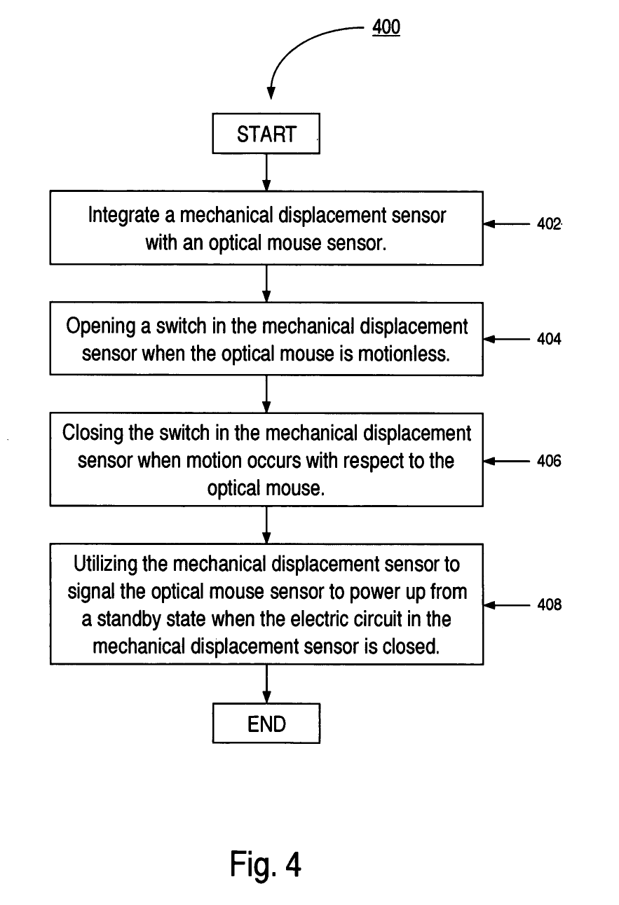

With reference now to FIG. 4 and to FIG. 3, a flow chart 400 summarizing the steps performed in accordance with one embodiment of the present invention is shown. At step 402, in one embodiment a mechanical displacement sensor 100 is integrated with an optical mouse sensor 250. As stated herein, in one embodiment, the mechanical displacement sensor 100 may be an integrated add-on to the optical mouse sensor 250 circuit. In another embodiment, the mechanical displacement sensor 100 may be manufactured as a component of the circuit including optical mouse sensor 250.

With reference now to step 404 of FIG. 4 and to FIG. 1, in one embodiment, a switch 104 in the mechanical displacement sensor 100 is open when the optical mouse is motionless. As described herein, in one embodiment, the switch 104 defaults to the open position. Furthermore, there is almost zero current consumption when the switch 104 is in the default (e.g., open) position. Therefore, when there is no motion with respect to the optical mouse containing the optical mouse sensor 250, the mechanical displacement sensor 100 does not drain the batteries of a wireless mouse.

With reference now to step 406 of FIG. 4 and to FIG. 1, in one embodiment, the switch 104 in the mechanical displacement sensor 100 closes when motion occurs with respect to the optical mouse. As described herein, in one embodiment, the switch 104 closes only for a fraction of time. When the switch 104 is closed the buffer 108 outputs a high state (e.g., a voltage) at voltage sensor 106.

With reference now to step 408 of FIG. 4 and to FIG. 1, in one embodiment, the mechanical displacement sensor 100 is utilized to signal the optical mouse sensor 250 to power up from the standby state when the switch 104 closes. That is, the high state of the output buffer 108 of the mechanical displacement sensor 100 signals the optical mouse sensor 250 (via power management control circuit 330 of FIG. 3) to wake up from hibernation (e.g., a powered-down state).

Thus, the present invention provides a system and method for power management of an optical mouse. The present invention further provides a method and system for power management of an optical mouse which requires no extraneous user interaction to power-up an optical mouse from a powered down state. The present invention further provides a method and system for power management of an optical mouse which achieves the above accomplishment and which can be adapted to readily interface with industry standard components and previously manufactured devices.

The foregoing descriptions of specific embodiments of the present invention have been presented for purposes of illustration and description. They are not intended to be exhaustive or to limit the invention to the precise forms disclosed, and modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. An optical mouse comprising:
an optical mouse sensor; and
a mechanical displacement sensor coupled to said optical mouse sensor to power up the optical mouse sensor from a standby mode when movement of said optical mouse is detected by said mechanical displacement sensor.

2. The optical mouse of claim 1 wherein said mechanical displacement sensor comprises:
a switch which sets to a first state when no movement is detected and sets to a second state when movement is detected, wherein said first state corresponds to said standby mode and said second state corresponds to a powered-up mode.

3. The optical mouse of claim 1 wherein said mechanical displacement sensor comprises:
a buffer that outputs a high logic signal when said switch closes.

4. The optical mouse of claim 1 wherein during said standby mode of said optical mouse sensor, an analog and digital core of said optical mouse sensor is powered down.

5. The optical mouse of claim 1 wherein said optical mouse is wireless.

6. The optical mouse of claim 1 wherein said mechanical displacement sensor comprises an integrated add-on to an optical mouse sensor circuit.

7. A method of minimizing power consumption of an optical mouse comprising:
detecting movement of said optical mouse by a mechanical displacement sensor within said optical mouse;
causing the optical mouse to go into a standby mode of operation when the mechanical displacement sensor detects that the optical mouse is motionless; and
taking said optical mouse sensor out of said standby mode of operation when said mechanical displacement sensor senses that the optical mouse is moved.

8. The method as recited in claim 7 further comprising:
setting a switch of said mechanical displacement sensor to a first state when said optical mouse is motionless; and
setting said switch of said mechanical displacement sensor to a second state when said optical mouse is moved.

9. The method as recited in claim 7 wherein said switch defaults to an open state when no movement is detected.

10. The method as recited in claim 9 wherein said mechanical displacement sensor further comprises a buffer that outputs a high logic signal when said switch closes.

11. The method as recited in claim 7 further comprising:
powering down an analog and digital core of said optical mouse sensor when said optical mouse sensor is in said standby mode of operation.

12. The method as recited in claim 7 wherein said mechanical displacement sensor is integrated with an optical mouse sensor circuit.

13. The method as recited in claim 7 wherein said mechanical displacement sensor and said optical mouse sensor circuit comprise components manufactured on a same circuit board.

14. The method as recited in claim 7 wherein said optical mouse sensor consumes no current in said standby state.

15. The method as recited in claim 7 wherein said optical mouse comprise a wireless device.
